(19) United States
(12) Patent Application Publication
(10) Pub. No.: US 2020/0372110 A1
(43) Pub. Date: Nov. 26, 2020

(54) Method of creating a demographic based personalized pronunciation dictionary

(71) Applicant: Himanshu Kaul, Cedar Park, TX (US)

(72) Inventor: Himanshu Kaul, Cedar Park, TX (US)

(21) Appl. No.: 16/419,028

(22) Filed: May 22, 2019

(51) Int. Cl. G06F 17/27; G10L 15/02; G10L 15/28

(52) U.S. Cl. CPC G06F 17/2735; G10L 15/285; G10L 15/02

(57) ABSTRACT

The present invention is related to the method of creating a demographic based personalized pronunciation dictionary for a user wherein the method comprising: determining at least one demographic information of the user, receiving at least one voice input from the user in association with the at least one demographic information, determining at least one voice characteristics in association with the at least one voice input received from the user in association with the at least one demographic information, determining at least one non-demographic information, identifying at least one pronunciation information from a demographic specific pronunciation dictionary located in a database in association with the at least one non-demographic information, determining, upon receiving at least one voice input from the user in association with at least one non-demographic information, at least one voice characteristics in association with the at least one voice input received from the user in association with the at least one non-demographic information, creating a personalized pronunciation dictionary for the user and storing the personalized pronunciation dictionary for the user in the database.

### FIELD OF THE INVENTION

The present invention is related to a method for name pronunciation dictionary and more particularly to a method of creating a demographic based personalized pronunciation dictionary for a user.

### BACKGROUND OF THE INVENTION

Speech has been the most natural communication modality for humans for thousands of years and extends as the go-to mode for human-machine interaction. Automatic speech recognition (ASR) technology and natural language understanding (NLU) technology have advanced significantly in the past decade.

Voice-controlled devices are successful at recognizing requests like “set an alarm” or “set a reminder for mom's birthday on January 5^{th}” or “set my destination to Bargela real estates” or “give me the details for narayanswamy”. Some of these are having appropriate context often yield request that are incorrect.

One of the most important aspects of voice-controlled device is its ability to accurately receive and recognize speech and generate an appropriate response. An appropriate response to one user may not be as useful to another even their inputs are exactly identical. Thus, it is often beneficial to have as much information about the user in order to provide him or her with the relevant response.

Further, automatic speech recognition that involves people's names is difficult because names follow a long-tail distribution and they have no commonly accepted spelling or pronunciation. This poses significant challenges to contact dialing by voice. Thus, the present method deals with the aspect of general pronunciation modeling which involves grapheme to Phoneme models (G2P) which convert words into pronunciations and are ubiquitous in voice and text processing systems.

Thus there is need to overcome the above mentioned prior arts.

### SUMMARY OF THE INVENTION

The present invention is related to the method of creating a demographic based personalized pronunciation dictionary for a user wherein the method comprising: determining at least one demographic information of the user based on user information, receiving at least one voice input from the user in association with the at least one demographic information, determining at least one voice characteristics in association with the at least one voice input received from the user in association with the at least one demographic information, determining at least one non-demographic information, located in at least one user device, associated with the user, identifying at least one pronunciation information from a demographic specific pronunciation dictionary located in a database in association with the at least one non-demographic information, located in the at least one user device, associated with the user.

The method further comprises: determining, upon receiving at least one voice input from the user in association with at least one non-demographic information, at least one voice characteristics in association with the at least one voice input received from the user in association with the at least one non-demographic information, creating a personalized pronunciation dictionary for the user by associating the at least one demographic information of the user, the at least one voice characteristics of the user determined from the at least one voice input received in association with the at least one demographic information, the at least one non-demographic information, located in at least one user device, associated with the user, the at least one pronunciation information from the demographic specific pronunciation dictionary in association with the at least one non-demographic information, and the at least one voice characteristics of the user determined from the at least one voice input received in association with the at least one non-demographic information and storing the personalized pronunciation dictionary for the user in the database.

According to one aspect of the present invention, the personalized pronunciation dictionary (PPD) for user is created based on the demographic region where the demographic region is used to determine the way how a user pronounces entities or phonemes. Further, the personalized pronunciation dictionary (PPD) helps in user input or query completion more likely to be intended by the user and will more likely be welcomed and trusted by the user. This increase the efficiency of the user input process and improves the user experience. In this way, user acceptance rates of completion suggestions are increased. Further the personalized pronunciation involves a real time error detection along with implicitly learning from user's correction. The groundwork for personalized pronunciation of names is carried out by the language models derived from phone contact biasing and salient n-gram biasing wherein an n-grain is a contiguous sequence of n items from a given sample of text or speech. The items can be phonemes, syllables, letters, words or base pairs according to the application. The n-grams typically are collected from a text or speech corpus.

According to another aspect of the present invention, the personalized pronunciation dictionary (PPD) also helps for clarifying the meaning of homophones. Further, the method is configured to identify a word or phrase as a names identity to identify a language of origin associated with the named entity and transliterate the name entity to a word associated with the language of origin and generate a phoneme sequence in the language of origin using a grapheme to phoneme (G2P) converter.

In some embodiments, the personalized pronunciation dictionary (PPD) may be stored locally on the user's device and/at cloud based database. Moreover, the personalized pronunciation dictionary (PPD) of the users provides high recognition accuracy and understanding of freely spoken utterances containing proper names for example, names of persons, street, landmarks, songs, cities or other entities.

### BRIEF DESCRIPTION OF THE DRAWINGS

The foregoing and other objects, aspects and advantages are better understood from the following detailed description of a preferred embodiment of the invention with reference to the drawings, in which:

FIG. 1 is a block diagram of the preferred embodiment of the present invention.

### DETAILED DESCRIPTION OF THE INVENTION

The present computer-implemented process will be more completely understood through the following detailed description which should be read in conjunction with the attached drawing in which similar reference numbers indicate similar structures. All references cited above and in the following description are hereby expressly incorporated by reference.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The problem arises from a misunderstanding by foreign language speakers of target language alphabet pronunciation rules. This misunderstanding results in a non-standard but consistent set of spelling across all names for that foreign language in target language alphabet. This spelling may be very different from the way native speakers of the target language would have spelled the foreign names if they are provided with the actual pronunciation of the foreign names.

For example, a name, Mahesh using US English pronunciation rules will be pronounced in international phonetic alphabet (IPA) as “m ae h i ∫” where the actual pronunciation is more accurately “m Λ h el ∫”. Another example, Isla is pronounced as “isla” wherein it should be pronounced as “il [symbol] ”.

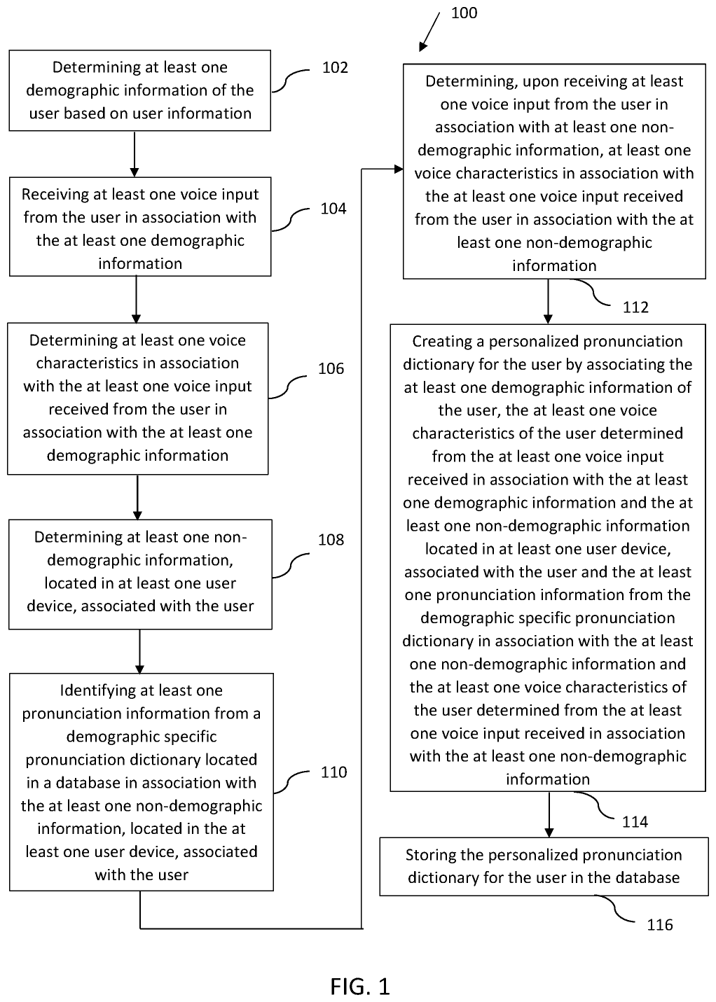

FIG. 1 is a flow chart illustrating the method of the present invention in accordance with the preferred embodiment. The present invention is related to the method of creating a demographic based personalized pronunciation dictionary for a user wherein the method comprising: At Step (102), determining at least one demographic information of the user based on user information wherein the at least one demographic information is one of the but not limited to age, gender, geographic location, nationality, region, race, education level, profession etc. At Step (104), receiving at least one voice input from the user in association with the at least one demographic information. At Step (106), determining at least one voice characteristics in association with the at least one voice input received from the user in association with the at least one demographic information wherein the at least one voice characteristics is configured to determine whether the voice is having characteristics of any demographic information. The voice characteristics of the user may be analyzed to identify demographics to which they may be likely to belong. At Step (108), determining at least one non-demographic information, located in at least one user device, associated with the user wherein the at least one non-demographic information is one of the but not limited to person name, contact name, place name, or any other word. The at least one user device may be a voice-controlled device, a voice assistant, a mobile phone or smart phone, a PDA etc. At Step (110), identifying at least one pronunciation information from a demographic specific pronunciation dictionary located in a database in association with the at least one non-demographic information, located in the at least one user device, associated with the user wherein the at least one pronunciation information is the pronunciation of the at least one non-demographic information based on the demographic information. For example, how a Spanish word “Ibiza” is pronounced according to the Spanish pronunciation. The pronunciation is configured to identify a name origin. Further, as another example, the method determines the word “pizza” pronunciation in the database of American English pronunciation and finds if there is some variation in how the word is pronounced by American speakers. Some approaches for identifying a name origin may include, but are not limited to, using existing name databases on the web, using a named entity recognition algorithm on a large corpus, searching for the name in open database, the Wikipedia corpus etc.

The method further comprises: At Step (112), determining, upon receiving at least one voice input from the user in association with at least one non-demographic information, at least one voice characteristics in association with the at least one voice input received from the user in association with the at least one non-demographic information. For example, an Indian person gives the voice input comprises of a Spanish word i.e. “Show me the pictures of Ibiza”, the method determines how the Indian person pronounce the word “Ibiza”. Further, At Step (114), creating a personalized pronunciation dictionary for the user by associating the at least one demographic information of the user, the at least one voice characteristics of the user determined from the at least one voice input received in association with the at least one demographic information and the at least one non-demographic information located in at least one user device, associated with the user and the at least one pronunciation information from the demographic specific pronunciation dictionary in association with the at least one non-demographic information and the at least one voice characteristics of the user determined from the at least one voice input received in association with the at least one non-demographic information. At Step (116), storing the personalized pronunciation dictionary for the user in the database wherein the database is a cloud based database.

In some embodiment, the method comprises determining at least one voice characteristics in association with the at least one voice input received from the user in association with the at least one demographic information wherein the at least one voice characteristics is used to identify pronunciation that may be unique to certain demographics. For example, once words and sound are correlated, the method determines whether the user elongates or shortens specific vowels sounds with specific words, whether the user tone of voice raises or lowers at the beginnings or ends of words, how the user says certain specific words and style of speech of the user. For instances, a user cultural origin may assist in identifying the pronunciation of an individual name which is “Jesus”. In certain cultures, the “J” is pronounced one particular way, but in others, the “j” is pronounced differently. Further, the at least one demographic information is gathered from the user profile. The profile of user is stored in the device and/or cloud based database.

According to one aspect of the present invention, the personalized pronunciation dictionary (PPD) for user is created based on the demographic region where the demographic region is used to determine the way how a user pronounces entities or phonemes. The elocution of said entities or phonemes are routinely adapted to the personalized pronunciation dictionary (PPD) and are collectively trained it with other personalized pronunciation dictionary (PPD) obtained from the same demographic region thus contributes towards a demographic specific pronunciation dictionary (DSPD).

Initially for data collection the device asks each user to pronounce certain words in order to train a personalized pronunciation dictionary (PPD). Once the generalized demographic specific pronunciation dictionary (DSPD) is created to handle all plausible accents, the demographic specific pronunciation dictionary (DSPD) can predict how a new user or a user with the personalized pronunciation dictionary (PPD) will pronounce other named-entities. This is achieved through feature extraction of accents and generalizing across a demographic region.

According to another aspect of the present invention, the method uses deep neural network (DNN) based acoustic model constructed from supervised data that is manually transcribed. The invention uses TIMIT corpus, which is an acoustic-phoneme continuous speech corpus. The TIMIT corpus has a speech sampling frequency of 16 KHz and is recurrently trained on the acoustic model. TIMIT speech corpus predicts the probabilities of word pairs that may be context dependent and/or independent phonemes based on the acoustic features of the voice input.

In some embodiments, the method uses deep neural network model (e.g., an acoustic and language model for speech recognition). The method uses hierarchical SoftMax normalization. To train the language model, the method used FastText model wherein FastText is based on a skip-gram model that trains quickly on a large unlabeled corpus and performs word embedding even for those that previously did not appear in the training dataset and this helps the device to map rare combination of alphabets to train the language model.

According to one exemplary embodiment of the present invention the personalized pronunciation dictionary may having database of all possible words to use in inputting voice commands, grammar of possible phrases, possible interpretation of the inputted voice command, data from various data sources and language models.

According to another exemplary embodiment of the present invention, the method is used for training a language model with queries, to build personal language models corresponding to each user. Further, the method includes automated speech recognition (ASR), and may utilize a plurality of models, such as pronunciations, vocabularies, language models and many more for analysis of the user voice inputs. Personal language models may be biased for user name, accent, geographical location, user history. Thus, due to the user dynamic voice development, the user is set free from constraints how to speak, the user is enabled to give the voice commands free from grammatical constraints.

In some embodiments the end-to-end speech recognition is built using a Recurrent Neural Network (RNN). Recurrent Neural Network-transducer is unaffected by apparent distortions from multiple users, accents and speech rate. LSTM helps for storage and recollection of data over time. The method uses Cold Fusion (Deep Search 3) to encourage a Seq2Seq model to constantly learn while training the language model. Using Cold Fusion, the word error rate (WER) is reduced to 11.52% from 22.5%. Further, Multi-Layer Perceptron (MLP) is trained on a large dataset and transforms acoustic signals into a context and language independent representation. Each name within the user's contacts is trained on the MLP and this is compared with entries in a name's dataset. This helps to gauge rough demographic origin of these names.

Advantageously, the MLP would be trained for recognizing phonemes in a specific language, for example it can be trained for recognizing 50 English phonemes, or between 30 and 200 English phonemes. In one embodiment it is possible to train multiple MLPs for different languages, for example an MLP for recognizing French phonemes and an MLP for recognizing English phonemes. In one embodiment, a single multilingual MLP can be trained for recognizing phonemes in several languages.

According to another exemplary embodiment of the present invention, the user demographic information can include any information helpful to determining the vocabulary. Moreover, the method configured to generate name pronunciations accurately with different languages. In one example, the user is free to pronounce the words in the native language, the device will understand the context of the user based on the user personalized pronunciation dictionary.

According to another exemplary embodiment of the present invention, the personalized pronunciation dictionary is adapted to cope with variants and/or peculiarities of pronunciation of speakers, for example, pronunciations of non-native speakers of a language and/or pronunciation of certain dialects.

It will be apparent from this list that although specific embodiments of the present invention are illustrated and described in this specification, modifications of those embodiments may be made without departing from the present invention concept.

1. A method of creating a demographic based personalized pronunciation dictionary for a user comprising
determining at least one non-demographic information, located in at least one user device, associated with the user;
identifying at least one pronunciation information from a demographic specific pronunciation dictionary located in a database, in association with the at least one non-demographic information, located in the at least one user device, associated with the user;
determining, upon receiving at least one voice input from the user in association with at least one non-demographic information, at least one voice characteristics in association with the at least one voice input received from the user in association with the at least one non-demographic information;
creating a personalized pronunciation dictionary for the user by associating the at least one non-demographic information, located in at least one user device, associated with the user, the at least one pronunciation information from the demographic specific pronunciation dictionary in association with the at least one non-demographic information, and the at least one voice characteristics of the user determined from the at least one voice input received in association with the at least one non-demographic information and
storing the personalized pronunciation dictionary for the user in the database.

2. The method of claim 1 further determine at least one demographic information of the user based on user information.

3. The method of claim 2 further determine, upon receiving at least one voice input from the user in association with the at least one demographic information, at least one voice characteristics in association with the at least one voice input received from the user in association with the at least one demographic information.

4. The method of claim 1 further associate the at least one demographic information of the user, the at least one voice characteristics of the user determined from the at least one voice input received in association with the at least one demographic information, the at least one non-demographic information, located in at least one user device, associated with the user, the at least one pronunciation information from the demographic specific pronunciation dictionary in association with the at least one non-demographic information, and the at least one voice characteristics of the user determined from the at least one voice input received in association with the at least one non-demographic information.

5. The method of claim 1, wherein at least one demographic information is at least one of a name of a person, museum, eating place, literature, message, or name of an article of manufacture.

6. The method of claim 1, wherein at least one non-demographic information is at least one of a name of a person, museum, eating place, literature, message, or name of an article of manufacture.

7. A method of creating a demographic based personalized pronunciation dictionary for a user comprising:
determining at least one demographic information of the user based on user information;
determining, upon receiving at east one voice input from the user in association with the at least one demographic information, at least one voice characteristics in association with the at least one voice input received from the user in association with the at least one demographic information;
determining at least one non-demographic information, located in at least one user device, associated with the user;
identifying at least one pronunciation information from a demographic specific pronunciation dictionary, located in a database, in association with the at least one non-demographic information, located in the at least one user device, associated with the user;
determining, upon receiving at least one voice input from the user in association with at least one non-demographic information, at least one voice characteristics in association with the at least one voice input received from the user in association with the at least one non-demographic information;
creating a personalized pronunciation dictionary for the user by associating the at least one demographic information of the user, the at least one voice characteristics of the user determined from the at least one voice input received in association with the at least one demographic information, the at least one non-demographic information, located in at least one user device, associated with the user,
the at least one pronunciation information from the demographic specific pronunciation dictionary in association with the at least one non-demographic information, and the at least one voice characteristics of the user determined from the at least one voice input received in association with the at least one non-demographic information; and
storing the personalized pronunciation dictionary for the user in the database.

8. The method of claim 7, wherein at least one demographic information is at least one of a name of a person, museum, eating place, literature, message, or name of an article of manufacture.

9. The method of claim 7, wherein at least one non-demographic information is at least one of a name of a person, museum, eating place, literature, message, or name of an article of manufacture.
